(19) United States
(12) Patent Application Publication
(10) Pub. No.: US 2026/0095785 A1
(43) Pub. Date: Apr. 2, 2026

(54) PREDICTED RADIO LINK FAILURE ENHANCEMENTS

(71) Applicant: InterDigital Patent Holdings, Inc., Wilmington, DE (US)

(72) Inventors: Oumer Teyeb, Montreal (CA); Brian Martin, Farnham (GB); Dylan Watts, Montreal (CA); Yugeswar Deenoo Narayanan Thangaraj, Chalfont, PA (US)

(73) Assignee: InterDigital Patent Holdings, Inc., Wilmington, DE (US)

(21) Appl. No.: 18/902,828

(22) Filed: Sep. 30, 2024

(51) Int. Cl. H04W 24/04; H04W 24/08

(52) U.S. Cl. CPC H04W 24/04; H04W 24/08

(57) ABSTRACT

A wireless transmit/receive unit (WTRU) may receive configuration information. The configuration information may include radio link problem prediction parameters and/or associated radio link recovery actions. The WTRU may monitor radio link conditions. The WTRU may predict, based on the radio link problem prediction parameters and/or the radio link conditions, an occurrence of a radio link problem within a period of time. The WTRU may determine that the prediction of the occurrence of the radio link problem is partially and/or fully fulfilled within a time window before or after the predicted period of time. The WTRU may perform the associated radio link recovery action based on the determination that the prediction of the occurrence of the radio link problem is partially and/or fully fulfilled within the time window before or after the predicted period of time.

### BACKGROUND

Artificial intelligence (AI) may refer to the behavior exhibited by machines. Such behavior may include, for example, mimic cognitive functions to sense, reason, adapt, and/or act.

Machine learning (ML) may refer to type of algorithms that solve a problem based on learning through experience (e.g., data), without (e.g., explicitly) being programmed (e.g., configuring set of rules). Machine learning can be considered as a subset of AI. Different machine learning paradigms may be envisioned based on the nature of data and/or feedback available to the learning algorithm. For example, a supervised learning approach may involve learning a function that maps input to an output based on labeled training example, where each training example may be a pair including input and the corresponding output. For example, unsupervised learning approach may involve detecting patterns in the data with no pre-existing labels. For example, reinforcement learning approach may involve performing sequence of actions in an environment to maximize the cumulative reward. In examples, it may be possible to apply machine learning algorithms using a combination and/or interpolation of the approaches described herein. For example, a semi-supervised learning approach may use a combination of a small amount of labeled data with a large amount of unlabeled data during training. In this regard, semi-supervised learning may fall between unsupervised learning (with no labeled training data) and supervised learning (with only labeled training data).

### SUMMARY

A WTRU may be configured to perform a prediction of radio link problem (e.g., N310 consecutive out of sync (OOSs), expiry of T310 time before 311 consecutive in syncs (ISs), etc.). A WTRU may be pre-configured with the actions to be taken (e.g., conditional handover (CHO), lower-layer triggered mobility (LTM), re-establishment, etc.,) and/or the conditions when (e.g., after the initial radio link problem/failure prediction) the action(s) to be taken. The conditions may be based on WTRU prediction of a radio link problem/failure and/or further partial and/or full validation/prediction that the problem is happening/has happened as expected (e.g., within a given time duration from the time when it was initially predicted to happen).

A WTRU may be configured to send a prediction report upon fulfillment of certain conditions (e.g., confidence level above a threshold, problem predicted to occur within a time window/instance, etc.,) and/or may further include measurement information in the prediction report. A WTRU may be configured to receive a response message from the network after sending the prediction report, indicating one or more WTRU actions to be taken and/or further conditions when the actions are to be taken. A WTRU may monitor the conditions for performing the WTRU actions and/or performing the actions when/if the conditions get fulfilled, and/or may send an indication to the network (e.g., indicating the action was taken before the radio link problem was actually detected based on predictions). A WTRU may send an indication to the network indicating that the action was not taken because conditions were not fulfilled.

A WTRU may receive, via a transceiver, configuration information. The configuration information may include radio link problem prediction parameters and/or associated radio link recovery actions. The WTRU may monitor radio link conditions. The WTRU may predict, based on the radio link problem prediction parameters and/or the radio link conditions, an occurrence of a radio link problem within a period of time. The WTRU may use non-AI/ML model (e.g., one or more statistical model(s), time series forecasting, etc.) and/or AI/ML model(s) predict the occurrence of the radio link problem within the period of time. The WTRU may determine that the prediction of the occurrence of the radio link problem is partially and/or fully fulfilled within a time window before or after the predicted period of time. The WTRU may perform the associated radio link recovery action based on the determination that the prediction of the occurrence of the radio link problem is partially and/or fully fulfilled within the time window before or after the predicted period of time.

The configuration information may include reporting conditions. The WTRU may send a report based on the reporting condition(s). The WTRU may use at least one artificial intelligence (AI)/machine learning (ML) model to predict the occurrence of the radio link problem. The WTRU may send, via the transceiver, capability information, of the WTRU, related to the radio link problem.

Determining that the prediction of the occurrence of the radio link problem is partially fulfilled may include the WTRU determining a percentage and/or a number of out of sync (OOS) indicators are detected. For example, the WTRU may determine that the prediction of the occurrence is partially fulfilled when a certain percentage and/or number of OOS are detected (e.g., as compared to the N310). Determining that the prediction of the occurrence of the radio link problem is fully fulfilled may include the WTRU determining when the radio link problem gets (e.g., actually) detected (e.g., N310 consecutive OOS detected).

The WTRU may perform a second prediction to determine whether there will not be a radio link recovery within a period of time. The WTRU may monitor in sync (IS) indicators to determine whether there will not be radio link recovery within the period of time. The WTRU may perform the associated radio link recovery action, for example, based on the second prediction and/or a determination that there will not be radio link recovery within the period of time. The associated radio link recovery action(s) may include one or more of: applying a radio resource reconfiguration message, applying a recovery mechanism to recover and/or maintain radio link connection, and/or executing radio link re-establishment.

The WTRU may send a prediction report based on the prediction of the occurrence of the radio link problem within the period of time. The WTRU may receive a response message. The response message may include an indication of one or more actions the WTRU is to take, and/or one or more conditions associated with the one or more indicated actions. The WTRU may execute a handover, conditional handover, and/or lower-layered trigger mobility action, for example, based on a determination that radio link recover is not likely to occur.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example diagram that summarizes the RLM and RLF detection procedures.

FIG. 3 depicts a high-level overview of the handover procedure (e.g., in NR).

FIG. 4 depicts an example flow chart diagram of one or more embodiments described herein.

### DETAILED DESCRIPTION

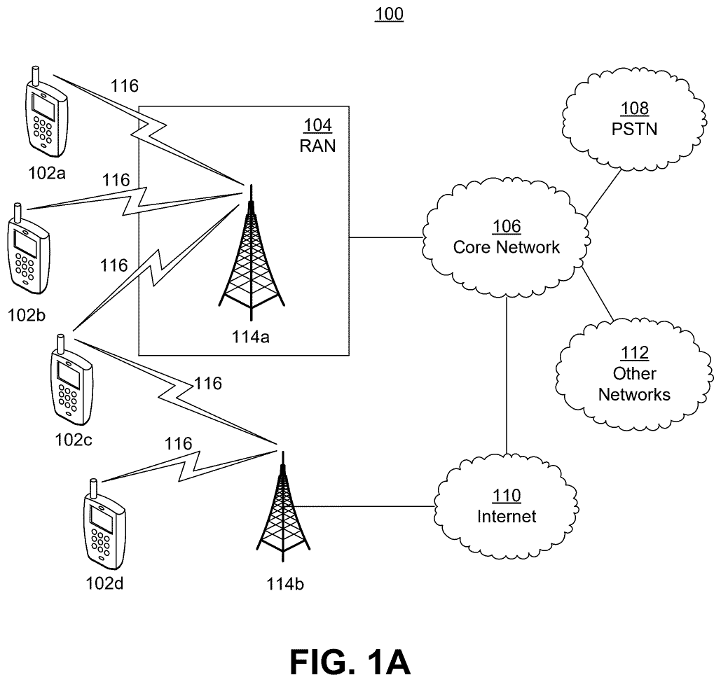

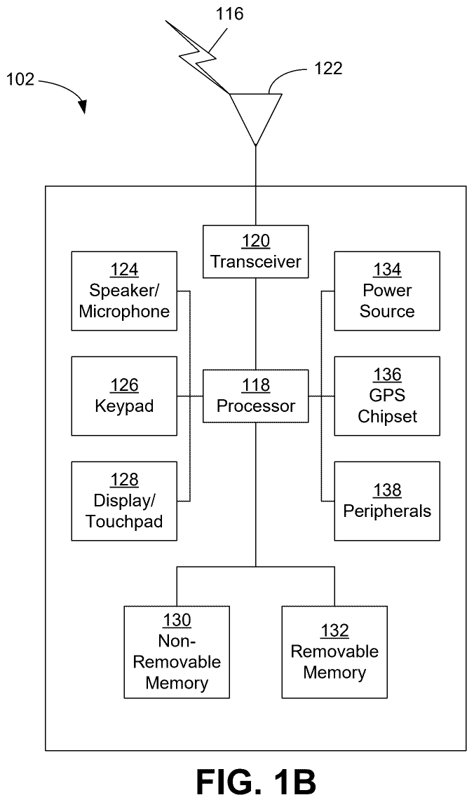

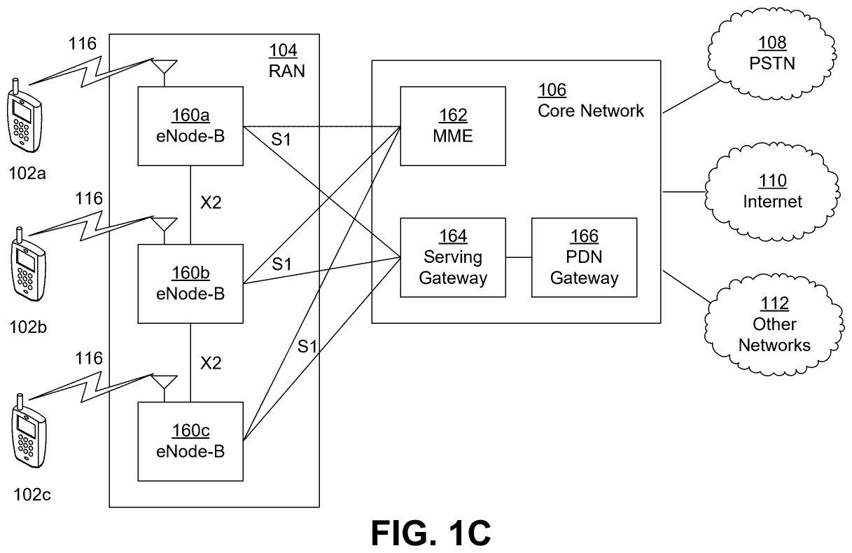

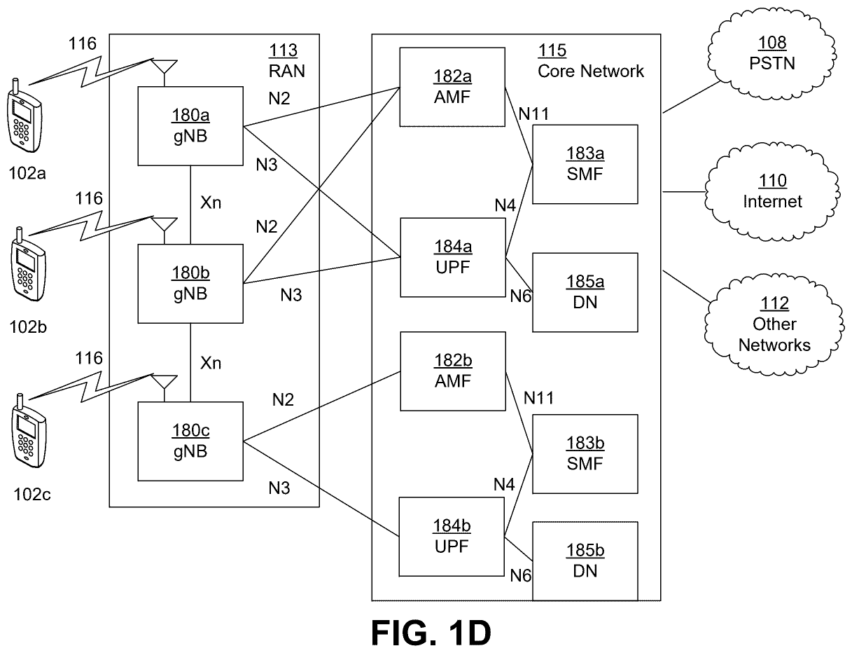

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

While in RRC_CONNECTED state, a WTRU may perform Radio Link Monitoring (RLM) on the serving cell (e.g., primary cell in the case of multiple cells configured for carrier aggregation). The WTRU may be configured with timers and/or counters to use when detecting Radio Link Failure (RLF) and/or performing radio link recovery and/or re-establishment. The physical layer (PHY) may send out of synchronization (sync) (OOS) and/or in sync (IS) indications to the radio resource control (RRC), based on whether the serving cell's signal to interference noise ratio (SINR) is below or above configured SINR thresholds (e.g., OOS indication sent from the PHY to the RRC if the SINR is below a first threshold, IS indication sent from the PHY to the RRC if the SINR is above a second threshold, etc.,). Upon the detection of N310 consecutive OOS indications from PHY, RRC may start a timer with a duration of T310. While T310 is running, the WTRU may attempt to recover the radio link on the serving cell. If N311 consecutive IS indications are received at RRC from PHY, the timer may be stopped, and/or the WTRU may consider the radio link to have been recovered and/or may resume (e.g., normal) operation and continues RLM on the serving cell. If T310 expires before the N311 consecutive IS indications are received, the WTRU may consider this as an RLF. Upon detection of RLF, a timer may be started with the duration of T311, and/or the WTRU may perform a cell search in order to determine whether there is a suitable cell available on which the WTRU may perform RRC connection re-establishment. If the timer T311 expires before the WTRU finds a suitable cell, the WTRU may enter RRC_IDLE mode with the cause RRC Connection failure. If the WTRU does find a suitable cell (e.g., which could be the original serving cell) then this cell may be selected, T311 may be stopped, T301 may be started, and/or an RRC Connection re-establishment procedure may be started. If the timer T301 expires before the RRC Connection re-establishment is complete, the WTRU may enter idle mode with the cause RRC Connection failure.

An RLF may occur, for example, when the WTRU goes out of coverage (e.g. entering a tunnel and/or moving to a rural area out of cellular coverage). An RLF may occur, for example, as a result of too late handover, whereby RLF is detected on the serving cell before a handover can be completed. A part of the procedure (N310, T310, N311) may be intended to allow the WTRU a chance to recover the radio link in case of a temporary problem. Another part of the procedure after T310 expiry may be intended to allow the WTRU to attempt to re-establish the connection on the same or another cell without having to release the connection completely.

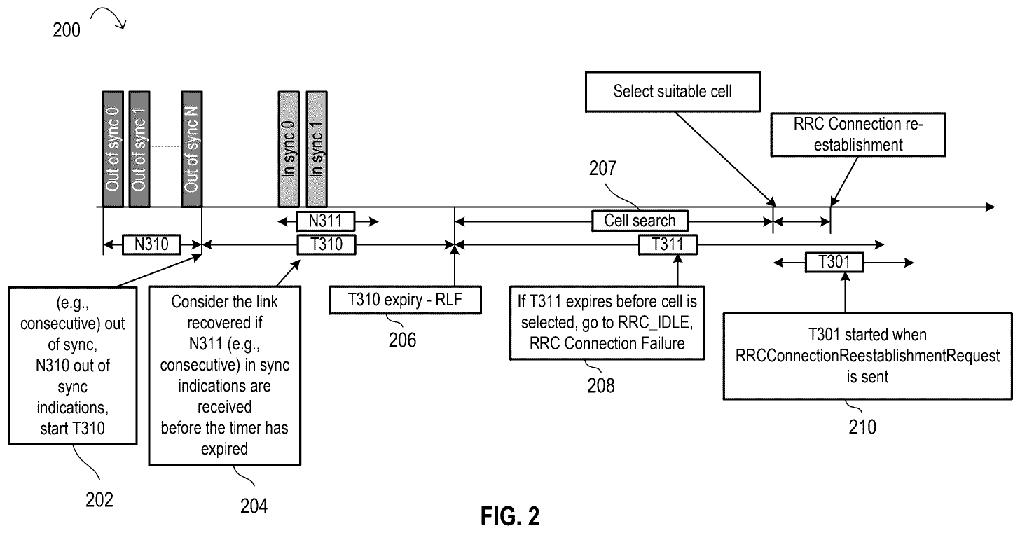

FIG. 2 depicts an example diagram that summarizes the RLM and RLF detection procedures 200. The WTRU may monitor the reception of an OOS and/or IS indication(s) from the PHY layer. At 202, upon the determination that N310 consecutive OOSs has been received, the WTRU may start a timer with a value equal to the configured T310. At 204, the WTRU may consider the link recovered if N311 consecutive in sync indications are received before the timer has expired. At 206, the WTRU may have determined that T310 has expired before the detection of the N311 consecutive in sync indications and/or may consider that a RLF has been detected . . . At 207, after detecting an RLF, the WTRU may perform a cell search. At 208, if T311 expires before cell is selected, the WTRU may go to RRC_IDLE, and/or RRC connection may fail. At 210, T301 may be started when RRCConnectionReestablishmentRequest is sent to re-establish connection with a cell.

Embodiments described herein may include using artificial intelligence (AI)/machine learning (ML). AI/ML enhancements may include network triggered L3-based handover (e.g., handover triggered by the network based on information received by the WTRU, such as measurement reports). Embodiments based on RLF and/or handover failure (HOF) predictions may be described herein.

A RLF detection procedure may have one or more (e.g., two) phases. For example, a first phase (e.g., phase 1) may include a radio link problem detection phase (e.g., time until N310 consecutive out of sync detections). For example, a second phase (e.g., phase 2) may include the radio link recovery phase (e.g., the time where T310 is running). RLF prediction discussion (e.g., in 3GPP) so far may have been considering the two phases as one (e.g., the model predicting when and/or during which time window the RLF is expected to occur, for example, the T310 expiry).

Considering T310 values can be configured to be long (up to 2 seconds), and n310 can be set 20 and n311 can be set to 10, the probability/confidence level of correctly predicting both the radio link problem happening and whether recovery will happen before the T310 expires can end up being low (e.g., especially if this prediction is to be sent to the network well in advance before the radio link starts having a problem). An approach may include performing the prediction of the two phases separately. For example, the prediction of a radio link problem being detected (e.g., N310 consecutive out of sync) can be made with more accuracy and/or more earlier than the whole RLF detection, and/or such information can be provided to the network (e.g., while the link is still OK), and/or the network could be able to reconfigure/handover (HO) the WTRU and/or the WTRU may take (e.g., autonomous) actions for a faster recovery of the link (e.g., execute a CHO/LTM, re-establishment, etc.).

Embodiments herein may address how to enable faster/pre-emptive recovery from an anticipated radio link problem/failure. Methods for predicting (and/or reporting) anticipated radio link problems/failures and/or earlier recover based on further (e.g., partial) verification of the accuracy of earlier predictions (e.g., and/or network response to the failure prediction report) may be described herein.

A WTRU may send capability information related to radio link problem detection (e.g., based on AI/ML model). For example, the WTRU may send, via the transceiver, capability information, of the WTRU, related to the radio link problem.

A WTRU may receive a configuration of radio link problem prediction parameters and/or reporting conditions (e.g., n310 value, a number of OOSs (not necessarily consecutive) anticipated within a given duration, lead time for sending the report as compared to the anticipated occurrence of the first and/or last OOS that leads to the n310 consecutive OOSs, etc.). For example, the WTRU may receive, via a transceiver, configuration information. The configuration information may include radio link problem prediction parameters (e.g., parameters including N310 that the WTRU may need to check and/or predict) and/or associated radio link recovery actions. For example, the WTRU may receive configuration information that includes the number of OOS required to determine a radio link problem has happened and/or the number of in sync (IS) required to determine the radio link has recovered (and/or to predict if recovery is going to happen before T310 expires). The configuration information may include one or more reporting conditions. The WTRU may receive one or more of the following configurations: configuration related to reduction of a radio link problem; configuration to radio link recovery action(s) to be taken based on a predicted radio link problem, and/or configuration related to conditions for performing the action(s). The condition(s) may be related to the partial and/or full fulfillment of the predictions.

The WTRU may monitor radio link conditions.

A WTRU may perform the prediction of radio link problem and/or may send the report when the reporting condition(s) are fulfilled. For example, the WTRU may send the report based on the one or more reporting conditions. A WTRU may be configured to include neighbor cell measurements in the report. The WTRU may predict, based on the radio link problem prediction parameters and/or the radio link conditions, an occurrence of the radio link problem within a period of time. For example, the WTRU may use one or more AI/ML models to predict the occurrence of the radio link problem. The WTRU may predict that there is going to be a radio link problem (e.g., N310 consecutive OOS) at time t1 from now. The WTRU may determine that the prediction of the occurrence of the radio link problem is partially and/or fully fulfilled within a time window before and/or after the predicted period of time. A WTRU configured to determine that the prediction of the occurrence of the radio link problem may include a WTRU configured to determine that a percentage and/or a number of (e.g., consecutive) out of sync (OOS) indicators are detected (e.g., as compared to the N310). For example, the WTRU may use a counter to keep the number of OOS and/or IS indications. A WTRU configured to determine that the prediction of the occurrence of the radio link problem is fully fulfilled may include a WTRU configured to determine that the radio link problem is (e.g., actually) detected (e.g., N310 consecutive OOS detected).

The WTRU may perform a second prediction to determine whether there will not be radio link recovery within a period of time. The WTRU may use one or more AI/ML models to perform the second prediction. The WTRU may monitor in sync (IS) indicators to determine whether there will not be radio link recovery within the period of time. For example, N311 consecutive ISs may be detected within a certain time, for example, T310, after the radio link problem is detected.

A WTRU may perform one or more of the following actions upon fulfillment of one or more conditions. If the WTRU notices that the radio link problem is going to happen partially and/or fully within a certain duration of the predicted time, the WTRU may perform one or more recovery actions. For example, the WTRU may start the recovery action (e.g., immediately). For example, the WTRU may start the T310 timer (e.g., without the need to wait for the whole N310 OOS, for example, at half of the OOSs), and/or (e.g., then) take an action (e.g., only) when T310 actually expires. For example, the WTRU may predict to determine if there will be recovery within T310 (e.g., the WTRU may perform a new prediction at that time to see if T310 is expected to expire before N311 ISs are detected). If the prediction is that there will be no recovery, the WTRU may take the recovery action already (e.g., no need to wait for T310). The WTRU may perform the associated radio link action based on the determination that the prediction of the occurrence of the radio link problem is partially and/or fully fulfilled within the time window before and/or after the predicted period of time. The WTRU may perform the associated radio link recovery action based on the second prediction and/or a determination that there will not be radio link recovery within the period of time. The associated radio link recovery action may include one or more of applying a radio resource reconfiguration message, applying a recovery mechanism to recover and/or maintain radio link connection, and/or executing radio link re-establishment. A WTRU may apply an RRC reconfiguration message (e.g., new RRC reconfiguration message received as a response to the radio link problem prediction report, an RRC reconfiguration message already stored in the WTRU, for example, CHO/LTM configuration). For example, the WTRU may execute handover (HO), conditional HO (CHO), and/or a LTM action based on a determination that radio link recovery is not likely to occur. A WTRU may apply a (e.g., new) t310 value (e.g., to extend and/or expediate the recovery). A WTRU may apply modified behavior in handling uplink (UL) data (e.g., suspend all UL transmission, suspend the UL transmission of user plane (UP) data, etc.). One or more conditions may include: i) within a given configured time from the sending of the report and/or the reception of the indication from the network; ii) if the reported radio problem is detected within the given time as the anticipated time (e.g., if N310 consecutive OOS get detected within a certain time window from the predicted time); iii) when a certain number of consecutive/total OOSs are detected (e.g., first OOS, n OOSs, N310 OOSs, etc.); and/or the like.

A WTRU may send one or more of the following indications. A WTRU may send an indication of a successful execution of the WTRU action (e.g., RRC reconfiguration complete message after performing the CHO/LTM, etc.). A WTRU may send an indication of a failure of predictions not coming true and/or the WTRU not executing the action(s) (e.g., if the radio link problem does not happen within a certain time window from the anticipated time, if radio link of the source gets recovered, etc.).

By providing an indication to the network of anticipated radio link problem while the radio lnk is still in good condition(s), the WTRU can be provided with configurations/indications that may enable faster recover (e.g., when the problem arises and/or before it does). The WTRU may (e.g., also, further) check if the anticipated radio link problem happens (and/or starts happening) before taking the (recover) action, instead of blindly trusting the predictions and/or performing a recovery action before the problem started to happen.

Artificial intelligence (AI) may refer to the behavior exhibited by machines. Such behavior may include, for example, mimic cognitive functions to sense, reason, adapt, and/or act.

Machine learning (ML) may refer to type of algorithms that solve a problem based on learning through experience (e.g., data), without (e.g., explicitly) being programmed (e.g., configuring set of rules). Machine learning can be considered as a subset of AI. Different machine learning paradigms may be envisioned based on the nature of data and/or feedback available to the learning algorithm. For example, a supervised learning approach may involve learning a function that maps input to an output based on labeled training example, where each training example may be a pair including input and the corresponding output. For example, unsupervised learning approach may involve detecting patterns in the data with no pre-existing labels. For example, reinforcement learning approach may involve performing sequence of actions in an environment to maximize the cumulative reward. In examples, it may be possible to apply machine learning algorithms using a combination and/or interpolation of the approaches described herein. For example, a semi-supervised learning approach may use a combination of a small amount of labeled data with a large amount of unlabeled data during training. In this regard, semi-supervised learning may fall between unsupervised learning (with no labeled training data) and supervised learning (with only labeled training data).

Deep learning may refer to class of machine learning algorithms that employ artificial neural networks (specifically DNNs) which were loosely inspired from biological systems. The Deep Neural Networks (DNNs) may be a special class of machine learning models inspired by human brain, where the input is linearly transformed and pass-through non-linear activation function one or more (e.g., multiple) times. DNNs may include one or more (e.g., multiple) layers, where each layer includes linear transformation and/or a given non-linear activation functions. The DNNs can be trained using the training data via back-propagation algorithm. DNNs may show state-of-the-art performance in one or more domains (e.g., speech, vision, natural language, etc.) and/or for one or more machine learning settings (e.g., supervised, unsupervised, and/or semi-supervised). The term AI/ML based methods/processing may refer to realization of behaviors and/or conformance to requirements by learning based on data, without explicit configuration of sequence of steps of actions. Such methods may enable learning complex behaviors, which might be difficult to specify and/or implement when using other (e.g., legacy) methods.

A given AI/ML model may be trained under certain WTRU and/or network side additional conditions. For example, a WTRU side condition could be the speed of the WTRU. Network side additional conditions may be related to one or more network configurations/settings that the WTRU may not be aware of, but may impact the performance of the model. For example, an RLF prediction model may perform differently if it is trained when the network was using a certain antenna pattern, beam pattern, power levels, and so on. Additionally or alternatively, there could be aspects related to network load, that may have impact on the model performance.

Since the WTRU may not need to know one or more (e.g., all) of the details of the network side additional conditions (e.g., and network may also not want to expose some of these implementation), the network could hide these details by signaling to the WTRU one or more associated ID(s). For example, when data is being collected for training a model, tagging may be performed indicating under which network side additional conditions the model is being trained. When a WTRU is being configured to perform the AI/ML based RLF prediction, the WTRU may be configured to check the consistency between the conditions under which the AI/ML model is trained on and current conditions (e.g., current WTRU conditions, current associated ID(s) signaled by the network indicating current network conditions/settings, etc.,)

In examples, the WTRU may perform the AI/ML based RLF prediction (e.g., only) if it has an AI/ML model that is applicable to the current WTRU and/or network side additional conditions. For example, the network may have communicated the current associated ID(s), and/or the WTRU has indicated that it has a model that is capable of working under the current WTRU conditions and/or associated ID(s); based on that, the network may have activated the AI/ML functionality at the WTRU. In case the applicability changes while the functionality is being used, for example, the WTRU may be configured to stop the AIML functionality and/or start using other (e.g., legacy) procedures (e.g., WTRU informing change of applicability to the network and/or network deactivating the functionality, WTRU autonomously deactivating the functionality when it determines applicability has changed, etc.,). The applicability change could be due to: the change in WTRU side conditions such as speed changes and/or the WTRU has no model trained for those conditions; and/or the associated ID changes and/or WTRU has no model trained for the other (e.g., new) associated ID. The associated ID change(s) could be due to: the WTRU performing a handover (HO) to a cell that is operating under different network conditions; the network changing one or more of its configurations without the WTRU performing a HO; etc.

The term Life cycle management (LCM) may refer to the overall management aspects of AI/ML models (e.g., model training, functionality/model identification, model delivery/transfer, model inference operation, functionality/model selection, activation, deactivation, switching, fallback operation, functionality/model monitoring, model update, WTRU capability, data collection, etc.). Functionality/model selection, activation, deactivation, switching, and/or fallback operation may include decision(s) by the network (e.g., network initiated and/or WTRU-initiated and/or requested to the network. Functionality/model selection, activation, deactivation, switching, and/or fallback operation may include one or more decision(s) by the WTRU (e.g., event-triggered as configured by the network, WTRU's decision reported to the network, and/or WTRU-autonomous either with WTRU's decision reported to the network or without it).

LCM can be functionality-based LCM and/or model-ID based LCM.

In functionality-based LCM, the network may indicate activation/deactivation/fallback/switching of AI/ML functionality via (e.g., 3GPP) signaling (e.g., radio resource control (RRC), medium access control control entity (MAC-CE), downlink control information (DCI)). Models may not be identified at the network, and/or the WTRU may perform model-level LCM. A WTRU may have one AI/ML model for the functionality, and/or the WTRU may have one or more AI/ML models for the functionality. In the functionality-based LCM, the WTRU may choose the AI/ML model to use for a certain functionality (e.g., network decides for which functionalities the WTRU can use AI/ML based operation, and/or the WTRU may choose the AI/ML model to use).

In model-ID-based LCM, models may be identified at the network, and/or the network and/or the WTRU may activate/deactivate/select/switch individual AI/ML models via model ID. In the model-ID based LCM, the network may (e.g., explicitly) control which particular model is used for a given AI/ML functionality. For example, the WTRU may provide details of AI/ML models and/or their capabilities, and/or the network may determine which model to activate for a particular functionality.

The embodiments descriptions herein may be applicable to (e.g., both) model-ID based and/or functionality-based LCM. Embodiments may be related to how the WTRU determines whether it has a model that is applicable for the indicated associated ID(s). For example, in the case of functionality-based LCM, the WTRU may be configured/requested to determine if a given functionality is valid/applicable, and/or it may do the determination among one or more (e.g., all) the models it has for a given functionality and/or may consider the functionality applicable if at least one of the models is applicable. In examples, in the case of model-ID based LCM, the WTRU may be configured/requested by the network to determine whether a particular model is applicable or not.

A WTRU may be configured for radio resource management (RRM) measurement configuration (e.g. to measure certain cells, frequencies, etc.), and/or the WTRU may send a measurement report (e.g., periodically) and/or upon the fulfillment of an event (e.g., A3 event, when the signal from a neighbor cell to the WTRU has a signal strength stronger than that from the serving cell by more than a certain threshold).

The network (e.g., based on the RRM measurement reports) may decide to handover (HO) the WTRU to one of the neighbor cells. The HO may be decided by the network without reception of a measurement report. Additionally or alternatively, HO may be performed due to load balancing and/or energy saving purposes (e.g., not necessarily due to radio signal levels).

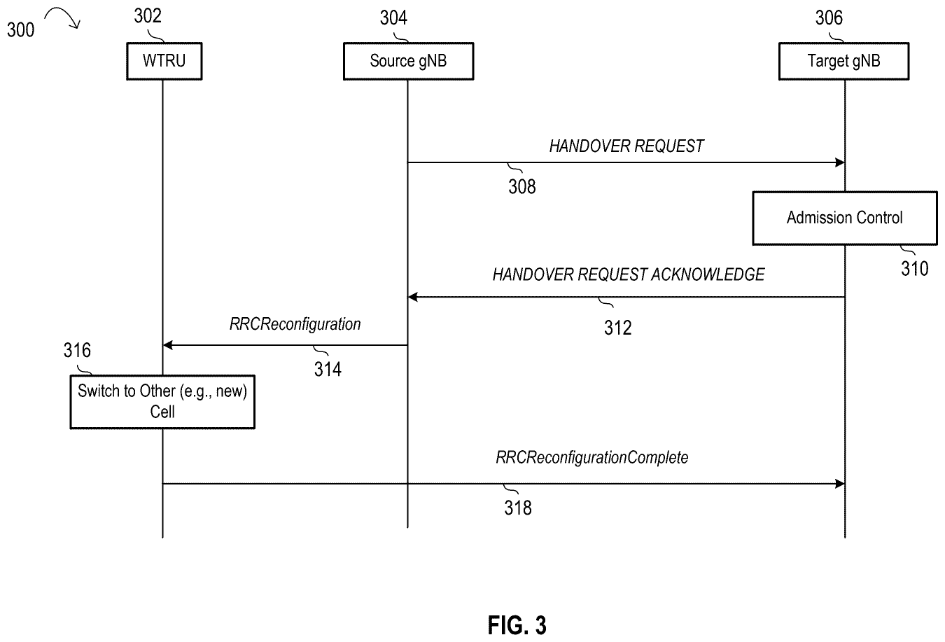

FIG. 3 depicts a high level overview of the handover procedure 300 (e.g., in NR). At 308, the source gNB 304 may initiate handover and/or may issue a HANDOVER REQUEST over the Xn interface. For example, the source gNB 304 may send a handover request to a target gNB 306. At 310, the target gNB 306 may perform admission control and/or may provide the (e.g., new) RRC configuration as part of a HANDOVER REQUEST ACKNOWLEDGE message (e.g., sent at 312). At 312, target gNB 306 may send the HANDOVER REQUEST ACKNOWLEDGE message to the source gNB 304. At 314, the source gNB 304 may provide the RRC configuration to the WTRU 302, for example, by forwarding the RRCReconfiguration message received in the HANDOVER REQUEST ACKNOWLEDGE message (e.g., at 312). The RRCReconfiguration message may include at least cell ID and/or (e.g., all) information required to access the target cell so that the WTRU 302 can access the target cell without reading system information. In examples, the information required for contention-based and/or contention-free random access can be included in the RRCReconfiguration message. The RRCReconfiguration that may be used for handover purposes may (e.g., also) be referred to as the HO command. At 316, the WTRU 302 may switch to another (e.g., new) cell. For example, the WTRU 302 may move the RRC connection to the target gNB 308. At 318, the WTRU 302 may send a RRCReconfigurationComplete message to the target gNB 308. The RRCReconfigurationComplete message (e.g., 318) may be referred to as a HO complete message.

Conditional Handover (CHO) may be described herein. CHO may be an enhancement of the HO procedure, where the WTRU is (e.g., initially) prepared/configured with a HO command towards a target and/or associated radio conditions when the Ho command is to be executed. The WTRU, instead of executing the HO command immediately, may monitor the triggering conditions (e.g., if the target cell's radio signal level becomes better than the serving cell's by more than a threshold), and/or may execute the HO command (e.g., only) when that gets fulfilled. The CHO command could be sent when the radio conditions towards the current serving cells are favorable and/or may reduce the one or more (e.g., two) points of failure in handover (e.g., legacy handover). Points of failure in handover may include: i) risk failing to send the measurement report, for example, if the link quality to the current serving cell falls below acceptable levels when the measurement reports are triggered in normal handover; and/or ii) the failure to receive the handover command (e.g. if the link quality to the current serving cell falls below acceptable levels after the WTRU has sent the measurement report, but before it has received the HO command).

CHO may help to prevent unnecessary re-establishments in case of an RLF. For example, if the WTRU is configured with one or more (e.g., multiple) CHO targets and/or the WTRU experiences an RLF before the triggering conditions with one or more (e.g., any) of the targets gets fulfilled, operation (e.g., Legacy operation) may have resulted in RRC re-establishment procedure that may have incurred (e.g., considerable) interruption time for the bearers of the WTRU. In the case of CHO, for example, if the UE, after detecting an RLF, ends up a cell for which it has a CHO associated with (e.g., the target cell is already prepared for it), the WTRU may execute the HO command associated with this target cell directly, instead of continuing with the full re-establishment procedure.

L1/L2 triggered mobility (LTM) (e.g., 3GPP standardized) may be described herein. A WTRU may be pre-configured (e.g., like in the case of CHO) with RRC reconfiguration to apply upon switching (e.g., being handed over) from a source cell to a target cell. The WTRU may perform the switching/handover upon receiving a MAC CE indicating the cell switch (e.g., instead of autonomous handover in the case of CHO based on the fulfillment of measurement events). LTM may include improvements in handover latency and/or interruption time compared to Layer 3 based mobility. Like CHO, LTM configuration can be used for recovery during RLF instead of re-establishment (e.g., WTRU executing the LTM configuration if the cell selected after RLF detection was an LTM candidate cell).

Conditional LTM may be described herein. Conditional LTM may be similar to CHO, but may use the LTM configuration instead (e.g., WTRU executing LTM based on L1/L3 measurement events without waiting for the LTM MAC CE).

One or more embodiments described herein may be agnostic to: the kind of AI/ML model/technique used by the WTRU (e.g., the algorithm used, the mechanism such as neural network or what kind of neural network, for example, depth and parameters/weights of the network, etc.,); the origins of the model (e.g., WTRU vendor, operator, network vendor, etc.,); and/or how/where the training of the model is done (e.g., the input data used for the training, where the training is performed, if the training is performed offline and/or online, etc.,). The model may be trained based on historical observation of one or more WTRUs' actual measurements in different WTRU and/or network conditions (e.g., during certain time durations of the day, during certain days of the week, at different locations, different WTRU mobility patterns/speeds, under different network conditions that are visible to the WTRU such as frequency/bandwidth, etc., under different network configurations, which may be visible to the WTRU just as a network configuration index that is provided by the network at the time of training or data collection for the training, etc.,).

The terms AI/ML and AIML may be used interchangeably. The terms data, measurements, report, and/or results may be used interchangeably. The terms indication, information, and/or message may be used interchangeably. The terms current cell, serving cell, and/or source cell may be used interchangeably. The terms target cell and candidate cell may be used interchangeably. The terms handover and cell switching may be used interchangeably. The terms functionality and procedure may be used interchangeably. The terms execute, apply, and/or perform may be used interchangeably. The terms legacy and non-AI/ML may be used interchangeably.

Although the embodiments described herein includes predictions based on AI/ML models, the embodiments may (e.g., also) be applicable to one or more (e.g., any) other form of prediction that does not use AI/ML (e.g., time series forecasting, interpolation methods, etc.).

A WTRU may be capable to communicate between the WTRU and the network about the AI/ML capability of the WTRU (e.g., where the WTRU can indicate to the network the supported AIML models/functions, confidence level of predictions, time horizon of predictions (how far along in the future are the prediction being made), etc.). The WTRU may support one or more (e.g., several) AIML models for a certain functionality (e.g., with different prediction time horizons, prediction confidence levels, processing requirements, trained under/for operation in different frequencies/cells/location/times of day, etc.). A given AIML model can operate in different modes (e.g., with different levels of prediction confidence levels at different prediction time horizons, at different locations, frequencies, WTRU mobility pattern/speed, etc.).

The AIML model(s) can be available at the WTRU already trained, and/or the WTRU may be provided with an untrained AIML model and/or may perform the training by itself. The AIML model may be available at the WTRU already trained, and the WTRU may be enabled/configured to perform further training (e.g., for different conditions such as frequencies/cells/location/times of day, for the same conditions as the initial training but for increasing the level of confidence or/and the prediction time horizon, for different WTRU speeds, etc.). The AIML model may be available at the WTRU but not trained (e.g., at all) and/or (e.g., only) trained for certain WTRU/network conditions, and/or the WTRU may be configured to train the model (e.g. for the conditions that it is not trained for).

In examples, the WTRU may require one or more (e.g., some) configurations/inputs for performing the inference using an AIML model. For example, for indirect RLF prediction, the WTRU may need configuration associated with a certain number of beams/cells to measure to determine the prediction. In examples, the WTRU may communicate the required configuration/input as part of the capability information. In examples, the required configuration/input may be communicated to the network after capability request (e.g., based on explicit network request, if the WTRU gets configured to do AIML based RLF predictions, and/or it has determined that it is lacking the required configuration/input, etc.,).

The RLF prediction can be performed (e.g., either) directly and/or indirectly. In the direct prediction, the AIML model may provide a prediction of the probability of an RLF happening within a time window in the future. In the indirect prediction case, the model may (e.g., first) predict a time series of SINR values in the future and this may be used on the (e.g., legacy) RLF detection procedure (e.g., the occurrence of N310 consecutive out of syncs and then the expiry of the T310 before N311 consecutive in-syns), to derive the expected time of an RLF.

A given AIML functionality may be associated with a set of key performance indicators (KPIs) and/or metrics. For example, KPIs and/or metrics could include prediction accuracy, average and/or mean square difference between measured and predicted values, etc. For the indirect RLF prediction, for example, KPIs and/or metrics may include could be the SINR prediction accuracy and/or confidence level, the difference between the measured and predicted SINR levels, etc. For the direct RLF prediction, for example, KPIs and/or metrics could include one or more (e.g., any) KPIs used for ML based classification, such as: precision, recall, and/or f1 score. Precision may be calculated as: precision=(true positives)/(true positives+false positives). Recall may be calculated as: recall=(true positives)/(true positives+false negatives). F1 score may be calculated as: f1 score=2*(precision*recall)/(precision+recall). True positives may equal the number of instances where RLF has occurred during the predicted time window. False positives may equal the number of instances where RLF has not occurred within the predicted time window. False negatives may equal the number of instances where RLF has occurred even though it was not predicted to occur within a time window.

The KPIs described herein for the direct RLF prediction may be applicable for the indirect case (e.g., after the predicted SINR output of the AIML model is used to determine the probability of occurrence of an RLF within a given time window).

A WTRU may have one or more AIML models for radio link problem prediction; each may have performance levels that meet different KPI thresholds (e.g., WTRU may have 2 models, where one has an accuracy level of 90% and another one has an accuracy level of 95%, etc.), and/or the WTRU may inform the network during its capability reporting and/or after the capability reporting.

An RLF detection procedure may include two phases: phase 1) detection of radio link problem (e.g., N310 consecutive OOSs), and phase 2) detection if recovery happens within T310 after radio link problem was detected in phase 1 (e.g., no N311 consecutive OOSs are observed during the T310).

The WTRU may have an RLF model that is concerned about (e.g., only) phase 1, about (e.g., only) phase 2, and/or concerned about both phase 1 and phase 2. The WTRU may have different (e.g., AIML) models for predicting phase 1 and phase 2.

The WTRU may be configured to predict the occurrence of a certain number of consecutive OOSs (e.g., n1, where n1=N310, n1<N310, n1>N310, etc.) and/or may send a report based on that. For example, the WTRU may be configured to trigger the report a certain time duration before the anticipated occurrence of the first of these n1 consecutive OOSs. Additionally or alternatively, the WTRU may be configured to trigger the report a certain time duration before the anticipated occurrence of the last of these n1 consecutive OOSs.

Instead of and/or in addition to the lead time, the WTRU may be configured with a confidence level threshold of the prediction to trigger the report. For example, the WTRU may be configured to trigger the report if it predicts n1 consecutive OOSs within configured time duration (e.g., the first of the OOSs, the last of the OOSs, etc.,) at a confidence level of more than x1%, n2 consecutive OOSs within a configured time duration at a confidence level of more than x2%, etc.

The prediction may be the time duration before the consecutive OOSs (e.g., the first, the last, etc.,). That is, the confidence level threshold can be configured/fixed, and when the WTRU predicts the occurrence of the OOSs with a confidence level above this threshold, the WTRU may trigger the report.

A WTRU may send a prediction report, for example, based on the prediction of the occurrence of the radio link problem within the period of time. The WTRU may send the prediction report to a network, for example, upon predicting that the radio link problem is expected to happen with a given lead time. The radio link prediction report may include an indication that radio link problem is expected to happen (e.g., at some pre-configured time in the future). For example, as described herein, the WTRU may have been configured by the network to send the report when it predicts with a confidence level of more than threshold1 that N310 consecutive OOSs are to occur and/or that this is expected to occur within a certain configured time from now (e.g., lead time). When the network gets this indication, the network may (e.g., implicitly) know when the radio link problem is expected to occur. In examples, the configured lead time may be the time from the first OOS. In examples, the lead time may be the time from the last OOS out of the consecutive number of OOSs that may be predicted to conclude a radio link problem is likely to occur.

The report may include information related to the lead time in the report. For example, the WTRU may be configured to determine/predict when the radio link problem is going to be experienced and/or may indicate that in the report (e.g., if the confidence level of the prediction is above a certain threshold). This time information could be related to the time when the first OOS and/or the last OOS is expected to occur.

The time information could be an absolute time information and/or a relative time information (e.g., in ms). The WTRU may be configured with time duration indexes for relative time and/or may indicate (e.g., only) the index in the report (e.g., index=0 if lead time=10ms to 30 ms, index=1 if lead time=31 ms to 100 ms, index=2 if lead time=101 ms to 200 ms, index=3 if lead time>200 ms, etc.,).

Since the network knows that measurement sampling period for RLM (e.g., how often the PHY sends the OOS and IS indications to the RRC), if the radio link problem detection is based on consecutive OOSs, knowing the time when the first OOS of these consecutive OOSs occurs may implicitly inform the network about the time when the last OOS will occur, and/or vice versa. The WTRU may be configured to send the information about the first OOS and/or the last OOS, so that the network and WTRU have the same understanding.

If the radio link problem detection is based on the prediction/detection of non-consecutive OOSs (e.g., a certain number of OOSs within a given duration), then the network may not be able to figure out the occurrence of the first OOS from an indication about the last OOS and/or vice versa. In examples, the WTRU may be configured to report both the start and end time information (e.g., absolute time information for both, delta time information for both from the current time, absolute time information for the first OOS occurrence and delta information from that time for the last OOS occurrence, etc.,). Time index values can be employed as described herein (e.g., first time index value indicating the time from current time to the occurrence of the first OOS, second time index value indicating the time between the first OOS and the last OOS, etc.,).

The WTRU may be configured to include information regarding the predicted number of (e.g., consecutive) OOSs after the lead time. For example, the WTRU may be provided with the configuration of the lead time, and/or the WTRU may predict the maximum number of (consecutive) OOSs that it predicts to occur within that lead time and/or may send that information in the report (e.g., when the confidence level of the prediction goes above a certain confidence threshold). The WTRU may be configured to include the minimum number of consecutive OOSs that it predicts within the lead time as well. Additionally or alternatively, the WTRU may include information regarding the time or time duration when these maximum and/or minimum number of (e.g., consecutive) OOSs are expected to happen.

The WTRU may be configured to include information regarding one or more (e.g., multiple) time instances/windows in the report. For example, the WTRU may be configured to send information regarding the probability/confidence of the occurrence of the radio link problem in time duration 1 (e.g., current time to time1), time duration 2 (e.g., time1 to time2), time duration 3 (e.g., time 2 to time 3), etc.

The WTRU may be configured to include measurement information in the report. The measurement information may be related to current L3 measurements (e.g., filtered RSRP) of the primary cell (e.g., where RLM is being performed and RLF is being detected/predicted), other serving cells (e.g., secondary cells if the WTRU is operating in carrier aggregation mode with multiple cells), and/or non-serving/neighbor cells.

The measurement information may be related to predicted L3 measurements (e.g., for serving cells and/or neighbor cells). For example, the WTRU may include the following in the measurement information: current measurements (at the time of reporting); predicted measurements (at the time of the occurrence of the first OOS, out of the consecutive OOSs); predicted measurements (at the time of the occurrence of the last of the OOSs); and/or the like.

A WTRU may be configured to include information related to the current and/or predicted UL data activity at the WTRU (e.g., information like a buffer status report (BSR)). For example, the WTRU may include the current BSR, predicted BSR at the time of the first/last OSS occurrence, etc.

A WTRU may perform one or more actions based on the radio link problem prediction without sending a report (e.g., radio link problem prediction report).

A WTRU my receive a message (e.g., an RRC reconfiguration message, a L1/L2 indication such as a MAC CE and/or PDCCH order, etc. ,) in response to the radio link problem prediction. This message may include configuration of one or more of the following: a HO command; a CHO command; a (e.g., new) T310 value; a (e.g., new) N311 value; a (e.g., new) N310 value; and/or (e.g., any) configuration/information that can be provided via an RRC message and/or L1/L2 indication.

For example, the (e.g., new) N310/N311/T310 values could indicate the values that the WTRU may use in the actual detection of the radio link problem and/or RLF after the reception of this message. For example, the prediction was for N310=20, and the network responds with the message informing the WTRU if it detects 10 consecutive OOSs, and if the prediction at that time is still the rest of 10 OSSs are to occur, the WTRU may not need to wait for the actual detecting of the next 10 OSSs before starting the T310, and/or may apply CHO/LTM and/or re-establishment, etc.,

The L1/L2 indication could be an LTM MAC CE indicating a target cell. This could be related to an LTM to be executed (e.g., when conditions for taking the actions as discussed below are fulfilled) and/or may relate to an activation of an LTM configuration (e.g., WTRU starting to measure the LTM target cell if it was not doing so already, WTRU starting to monitor radio conditions associated with a conditional LTM configuration, etc.,)

The L1/L2 indication could be a L1/L2 indication (e.g., PDCCH order) indicating to the WTRU to perform an early sync with one or more neighbor (e.g., LTM candidate) cells, where the early sync procedure may include the sending of a random access channel (RACH) preamble to the target with or without a random access response (RAR) from the target (e.g., the target responding with a RAR indicating the timing advance, timing advance (TA), to apply for the UL transmission in case the WTRU is handed over to that cell, the source responding with a subsequent LTM MAC CE that includes the TA, etc.).

The WTRU may be configured with the actions to take beforehand (e.g., in an earlier message, specified in 3GPP specifications, etc.,). This is valid even in the case the WTRU was configured for sending the report. For example, the report from the WTRU can be for informational purposes and/or may be used by the network to prepare resources at the most likely neighbor cells that the WTRU may choose for recovery. In examples, the WTRU may be configured with a wait time duration, which specifies for how long the WTRU may wait in anticipation of a response message from the network. If a response from the network is not received within the wait time after the sending of the report, for example, the WTRU may take a pre-configured/pre-specified action when a pre-configured/specified conditions get fulfilled (as discussed herein).

The WTRU may be configured to take certain actions in response to radio link problem prediction and/or associated conditions that may be fulfilled before the WTRU takes the action (after the prediction of the radio link problem). The condition(s) for the WTRU action may specify when the WTRU applies the action after the prediction of the radio link problem. The condition(s) for the WTRU action may specify when the WTRU applies the action after the sending of the prediction report (if WTRU was configured to send the report). The condition for the WTRU action may specify when the WTRU applies the action after the reception of the response from the network (if the WTRU was configured to send the report and if the network sends a response message to that).

One or more combinations of how the WTRU is configured with the actions and/or conditions are described herein. WTRU actions may include reconfiguration (e.g., reconfiguration message received after sending a report, and/or a reconfiguration message already available at the WTRU such as CHO/LTM). Condition may include whether the predicted radio link problem has fully and/or partially occurred within a certain time duration (e.g., before or after) the predicted time. WTRU actions and/or conditions may be described in specifications. WTRU actions and/or conditions may be provided to the WTRU in an earlier reconfiguration (e.g., prior to the sending of the report, prior to and/or along with the configuration for radio link problem prediction, etc.). WTRU actions and/or corresponding conditions may be included in the response message from the network. WTRU actions in the response message from the network may include conditions in an earlier reconfiguration message and/or conditions in specifications (e.g., RRC). WTRU actions in an earlier reconfiguration message may include conditions in an earlier reconfiguration message and/or conditions in the response message. WTRU actions as specified in the specifications may include conditions in an earlier reconfiguration message and/or conditions in the response message. For example, a WTRU may receive the response message. The response message may include an indication of one or more actions the WTRU is to take, and/or one or more conditions associated with the one or more indicated actions.

One or more combinations of the action(s) and condition(s) may be described herein (e.g., one or more actions and/or conditions specified in 3GPP specifications, and/or WTRU receiving further actions and/or conditions in the response message to replace these default actions and/or conditions and/or to add to the WTRU actions to be taken and/or conditions to be considered).

The WTRU may be configured with one or more (e.g., several) actions to be taken, each with a corresponding condition. A certain action may have one or more (e.g., several) conditions associated with it (e.g., all these conditions may be fulfilled before the action is performed by the WTRU).

A WTRU may be configured with one or more (e.g., several) actions to be taken, but one condition for the one or more (e.g., all) of them (e.g., WTRU may perform all actions when the condition is fulfilled).

The condition for WTRU action may be related to time duration (e.g., a certain configured time duration, which may be equal to zero, indicating immediate application). For example, the WTRU may be configured to execute the WTRU action based on (e.g., immediately after) the prediction of radio link problem and/or based on (e.g., after) a certain time duration has elapsed (e.g., if the action was provided to the WTRU with a previous RRC reconfiguration and/or the action is specified in the 3GPP specifications). For example, the WTRU may execute the WTRU action (e.g., immediately) (and/or after a certain configured time duration has elapsed) after the sending of the prediction report. For example, the WTRU may execute the WTRU action (e.g., immediately) (and/or after a certain configured time duration has elapsed) after the reception of the response message.

The condition for WTRU action may be related to the actual detection of the predicted radio problem.

A WTRU may be configured to take the action at the start of the radio link problem. For example, if a WTRU detects an OOS, and that OOS has been detected within a certain configured time duration margin from the predicted start of the N310 consecutive OOSs, the WTRU may perform the WTRU action. The WTRU may be (e.g., further) configured to perform a (e.g., quick) prediction at that point in time (e.g., for the next N310−1 IS/OOS detection instances) to see if those are going to be OOSs as well. There may be some error margin threshold configured at the WTRU to consider this valid (e.g., it doesn't necessarily have to be a perfect match, for example, the current prediction may be marginally smaller than N310−1).

The WTRU may be configured to take the action in the middle of the radio link problem. For example, if the WTRU has detected a certain number of (and/or percentage of, relative to the N310) consecutive OOSs, and these OOSs have occurred within a certain configured time duration margin from the predicted time for these number of (and/or percentage of) OOSs to occur, the WTRU may perform the WTRU action. The WTRU may be (e.g., further) configured to perform a (e.g., quick) prediction at that point in time to see if the remaining number of OSSs are expected to be detected as well before taking the action.

The WTRU may be configured to take the action at the end of the radio link problem. For example, if the WTRU has detected the N310 consecutive OOSs and these have occurred within a certain time duration from the predicted time for the radio link problem, the WTRU may execute the UE action.

The WTRU may be configured to start the T310 timer earlier (e.g., than legacy, before the N310 consecutive OOSs) based on prediction. For example, the WTRU may be configured with N310=n. The WTRU may be configured to detect the OOSs (e.g., as in legacy), but when a certain number (n1<n) and/or percentage (n1/n=p<100%) of consecutive OOSs are detected, the WTRU may perform a prediction regarding whether the remaining OOSs will occur. If the prediction is positive with more than a certain confidence level, the WTRU may reset the IS/OOS counters and/or may (e.g., immediately) start the T310 timer.

The WTRU may be configured to start the T310 timer (e.g., as in legacy, when the N310 consecutive OOSs have been detected). The WTRU may be (e.g., further) configured to predict if the T310 is expected to expire before the required N311 consecutive ISs are detected. If the prediction is that T310 will expire (with a confidence level more than a certain threshold), the WTRU may stop the T310 timer (e.g., immediately). The WTRU may be configured to perform the prediction whether T310 is going to expire or not at the start of the T310 and/or any time after the start of the T310 (e.g., a configured time after the start of the T310, after a certain percentage of the T310 has already passed, after a certain number of OOSs or/and ISs have been detected after the start of the T310 timer, etc.,). The WTRU may be configured to perform the prediction whether T310 is going to expire even before the T310 has started (e.g., when a certain number or percentage of the N310 OOSs has been detected.)

Upon the expiry of the T310 timer (and/or earlier stoppage of the timer based on prediction as described above), the WTRU may perform associated recovery action(s) (e.g., re-establishment, recovery via CHO/LTM, apply an action/configuration that was provided to the WTRU in response to a radio link problem prediction report, etc.,).

The WTRU may be configured to apply different UL transmission behavior based on predicted/experienced radio link problem. The WTRU may be configured to suspend UL transmission a certain time duration before the expected start time of the radio link problem (e.g., a certain time duration before the expected time of occurrence of the first OOS of the N310 consecutive OOSs, a certain time duration before the expected time of occurrence of the last OOS of the N310 consecutive OOSs, etc.,). The suspension of the UL transmission may be based on the (e.g., partial) validation of the prediction (e.g., if the first/intermediate/last OOS happens within a certain duration of the predicted time for it, etc.,). The actions related to UL behavior modification and/or corresponding conditions may be provided to the UE (e.g., in the 3GPP specifications) as a response to the prediction report, and/or pre-configured beforehand (e.g., before the radio link prediction is performed). The UL transmission behavior can be applicable for (e.g., both) user plane and/or control plane data (e.g., applicable only to user plane data, applicable only to control plane data). For example, the UL transmission behavior can be applicable to both user plane and control plane data and/or the configuration (e.g., lead time for suspension, etc.,) can be different for user plane and control plane. The UL transmission behavior can be different between different control plane data (e.g., L3 control plane data such as RRC messages or lower layer signaling like MAC CEs or HARQ).

The WTRU may be configured with conditions when to resume the suspended UL transmission. For example, the WTRU may have suspended the UL transmission (e.g., CP data, UP data, and/or both), as discussed herein, on the detection of an intermediate OOS (out of the N310 OOSs) within a certain duration of the expected time for that to happen. If the WTRU determines that the rest of the OSSs are not being detected as expected, the WTRU may resume the UL transmission. In examples, if the WTRU has suspended an UL transmission, the WTRU may resume the UL transmission upon detecting the T310 is not going to expire before recovery. The WTRU may resume the suspended UL transmission upon determining the predictions that led to the suspension are not coming true and/or a later prediction with more confidence level is indicating that the predictions are not likely to come true.

A WTRU may be configured to send an indication to the network after taking the actions (e.g., as described herein). In examples, this may be the (e.g., legacy) message corresponding to the action taken, like the RRC reconfiguration complete message (e.g., after executing the HO/CHO/LTM, etc.,), and/or a L1/L2 indication that conveys a similar information without the (e.g., heavier) RRC signaling. In examples, the WTRU may be configured to include (e.g., further) information in the legacy (e.g., RRC reconfiguration message), such as including further information to the legacy message. For example, this could be information indicating that the action was taking differently from legacy. In (e.g., legacy) operation, after the WTRU has detected an RLF (e.g., T310 has expired), the WTRU may perform a cell re-selection; if there is a CHO/LTM configuration associated with the selected cell, the WTRU may execute the CHO/LTM configuration (e.g., instead of performing a re-establishment). If, according to the embodiments described herein, the WTRU has executed a CHO/LTM based on predicted RLF (e.g., before T310 has expired or even started, etc.,), the WTRU may include an indication (e.g., in the CHO/LTM complete message) that the CHO/LTM was performed due to predictions. (e.g., the indication including information such as the number of OOSs, confidence level of the radio problem predictions when the CHO/LTM was performed based on predictions, etc.

In examples, the WTRU may be configured to send another (e.g., new) message to the network that is different from the (e.g., legacy) RRC reconfiguration complete message. For example, the WTRU may be configured to send the (e.g., legacy) RRC reconfiguration complete message (and/or similar L1/L2 indication) if the action was taken after the radio link problem has been detected (e.g., N310 OOSs were actually detected), and/or the other (e.g., new) message if the action was taken before the radio problem has been actually detected (e.g., before N310 OOSs were actually detected, based on a high confidence level of a prediction that the N310 OOSs will be detected).

If the conditions for the execution of the action are not fulfilled, the WTRU may send an indication to the network. For example, if the WTRU has predicted that a radio link problem is to be experienced at a certain time and was configured to take an action based on that (e.g., execute an action when 50% of the OOSs have been detected within a configured time duration delta from the expected time), but the WTRU didn't detect the required number of OOSs within that time window, the WTRU may send the indication to the network, indicating that the predictions didn't come to be and the action was not taken.

If the WTRU has performed an earlier recovery to a target cell (e.g., before the radio link problem is actually detected,), the WTRU may be configured to keep performing RLM and/or RLF detection on the source cell for a certain time duration after it has pre-emptively performed the recovery action (e.g., after HO/CHO/LTM/re-establishment to a neighbor cell) to determine if the RLF would have actually occurred in that cell had the WTRU not performed the recovery action.

A WTRU may send an indication to the network regarding whether the predicted RLF would have occurred or not (e.g., prediction was accurate or not). If the prediction was accurate, the WTRU may include the exact time information when the RLF would have occurred and/or the relative time from when the pre-emptive recovery action was taken to the time when the RLF actually occurred. If the prediction was not accurate (e.g., RLF would not have occurred had the WTRU remained in the source cell), the WTRU may include information regarding that in the indication (e.g., link would have been recovered within the T310, and/or the N310 OOSs required to start the T310 timer were not detected to begin with).

A prediction failure may refer to the case where the action was not taken (e.g., conditions for triggering the action were not fulfilled after the initial prediction of radio link problem or radio link failure was predicted to trigger the action), and/or that the action was taken but later monitoring (e.g., RLM and RLF detection on the source cell after the pre-emptive recovery action has shown that radio link problem and/or the RLF would not have occurred had the WTRU stayed in the source cell). Prediction success may refer to one or more other cases (e.g., conditions for triggering the action were fulfilled and WTRU action taken, monitoring of the RLM/RLF detection on the source after the recovery action confirmed radio link problem and/or RLF would have occurred had the WTRU remained at the source cell).

Instead of sending the one or more success/failure indications, as described herein, to the network, for example, the WTRU may be configured to log such information (e.g., in a radio link problem prediction error log), and/or the WTRU may send the logged information (e.g., later) (e.g., based on explicit request from the network, when a certain number of such failures have been logged, when the total size of the log is above a certain size, etc.,). The WTRU may be configured to (e.g., opportunistically) send to the network that such a logged failure report is available (e.g. by including a flag in another UL message such as an RRC reconfiguration complete message), and/or the request from the network to send the report may be based on that. The network may request the WTRU to provide such logged information even without receiving such an indication from the network.

Sending of the success/failure indications (e.g., as described herein) could be used by the network to determine the performance (e.g., accuracy) of the prediction model at the WTRU; and/or based on that, for example, the WTRU may receive an indication to deactivate the prediction and/or start operating (e.g., as in legacy, no predictions of radio link problems and/associated WTRU actions for pre-emptive recovery). Additionally or alternatively, the WTRU may receive a request form the network to switch to other prediction model(s) (e.g., if the WTRU has indicated a more accurate model that was more expensive from processing/memory point of view).

Instead of and/or in addition to sending the success/failure indications and the network does the performance monitoring, the WTRU may be configured to do the performance monitoring. For example, the WTRU may be configured with KPIs (e.g., the number of prediction failures within a given time, the percentage of prediction failures within a given number of predictions and/or preemptive recovery actions, etc. ,) and/or associated thresholds; the WTRU may deactivate the prediction of radio link problem and/or RLF and/or may resort to other (e.g., legacy) operation (and/or switch to a stronger, e.g., more accurate model, if it has such a model available).

A combination may be described herein, where the WTRU monitors the KPIs, but instead of taking the deactivation and/or switching between models, the WTRU may inform the network when the KPIs fulfill and/or fail to fulfill one or more (e.g., some) configured thresholds and/or the WTRU may deactivate and/or switch between models (e.g., only) based on a (e.g., after) subsequent message from the network.

Examples described herein regarding prediction of phase 1 of the RLF detection procedure, may be applicable to the prediction of the phase 2 of the RLF detection procedure.

The WTRU may be configured to send a prediction report (e.g., prediction whether phase 1 of the RLF detection gets fulfilled) that may include information about the prediction of RLF (e.g., prediction whether phase 2 of the RLF detection gets fulfilled). The WTRU may send the prediction report based on the prediction of the occurrence of the radio link problem within the period of time. For example, the WTRU may indicate that in the report that phase 1 is expected to end at time t1 from now, and/or T310 is expected to expire before recovery of the link (e.g., with a certain confidence level, where the confidence level of the prediction of the phase1 and phase 2 may be different).

The WTRU may be configured to send a prediction report that may include information about phase 2 (e.g., only). For example, the prediction report may include the predicted information is that at a certain lead time, the WTRU is likely to have experienced N310 OOSs, have started the timer T310, and/or that timer would likely expire before the detection of N311 ISs.

Prediction confidence level may be likely to decrease the more far ahead is the prediction instance from the current time. The UE may be configured to consider different prediction confidence levels for the different time instances of the prediction. For example, in order to predict whether N310 OOSs are going to be predicted within a certain time window/lead, the model used for prediction can be used to generate a time series forecast of the SINR for each IS/OS detection instance, and each prediction sample may have different confidence level associated with it (e.g., N310=10, model generates 10 samples, each corresponding to SINR level at those instances and each associated with a confidence level, and/or these may be compared with the Qout threshold, and/or these may be translated to IS/OS samples). The WTRU may be configured to consider a confidence level threshold that is higher for the prediction samples that are closer in time from now than those farther away. For example, the first sample can be considered as an OOS if the prediction confidence for that one was c1, the second sample considered as an OOS if the prediction confidence for that was c2, and so on, where c1>c2> . . . cN310, etc. The WTRU may be configured with individual confidence level required for each sample and/or the WTRU may be configured with a confidence level required for the first sample and/or the others can be configured relative/delta to that one.

The WTRU may be configured to take alternative action(s) if the initial prediction of radio link problem (phase 1) and/or RLF (phase 2) (e.g., that was communicated to the network in the prediction report) do not come true.

The WTRU may be configured to send the radio link problem report regarding phase 1 and/or phase 2 upon explicit request from the network. A problem report (e.g., such as legacy RLF report) may indicate that an actual problem has been detected. For example, the WTRU may receive a message from the network requesting when a radio link problem is expected to be detected (e.g., at a confidence level greater than a certain threshold) and/or the WTRU may respond with a report (e.g., indicating the expected time of the detection of radio link problem, confidence level of the prediction, whether the radio link is expected to recover or not after that, the confidence level of the prediction of the link recovery, etc.,).

Additionally or alternatively, the WTRU may receive a message from the network requesting if a radio link problem or/and radio link failure is expected to be detected at a certain time and/or within a certain time window/duration. The WTRU may respond with a report (e.g., indicating whether the radio link problem and/or RLF is expected to happen during that time window and/or time instance, the confidence level of the radio link problem or/and RLF being detected, etc.).

The WTRU may be configured to send periodic prediction reports regarding phase 1 and/or phase 2 (e.g., every X seconds). A prediction report may indicate that a problem is expected to happen (e.g., at a given time in the future). The WTRU may be configured to send the periodic predictions (e.g., only) if certain conditions are fulfilled. For example, the WTRU may be configured with a reporting periodicity of X seconds, and every X seconds may make the predictions, and/or may send the report (e.g., only) if the conditions for reporting are fulfilled (e.g., if the confidence level of the prediction that a radio link problem or/and RLF is above a certain threshold, if the radio link and/or RLF is expected to happen within less than a certain configured lead time from now, etc.)

The WTRU may be configured to include predicted measurement events in the prediction report (e.g., instead of and/or in addition to the measurement reports). For example, the WTRU may be configured with an A3 like event (neighbor better than source by more than a certain threshold), and/or may indicate in the prediction report that by the time the radio link problem and/or RLF is expected, a certain target cell may fulfill the A3 conditions. This could be a list of cells that are expected to fulfill the A3 conditions at that time.

Additionally or alternatively, if the WTRU was configured to act without sending the prediction report and/or receiving a response message from the network, the WTRU may be configured to determine the action (e.g., CHO/LTM, etc.,) based on a prediction of a future measurement event. For example, the WTRU, upon predicting an RLF is expected to occur with a confidence level greater than a configured threshold, may pre-emptively execute a CHO to a target cell, based on the prediction that the target cell is expected to fulfill the radio conditions at the time when the RLF is expected to occur, even though the current conditions of the target may not fulfill the CHO/LTM triggering conditions. The WTRU may be configured to check if the current radio conditions towards the target are sufficient (e.g., good enough, for example, based on another configured threshold), even though they may not fulfill the CHO triggering thresholds. Other aspects like UL sync may also be considered (e.g., the WTRU may check if it already has an UL sync with the target, etc.).

The WTRU may be configured with prohibit timers related to the sending of radio link problem/failure prediction reports (e.g., not send a subsequent report within the configured prohibit timer). The prohibit timer could also be related to one or more WTRU actions based on prediction (e.g., WTRU configured not to take two actions based on predictions within the configured prohibit timer).

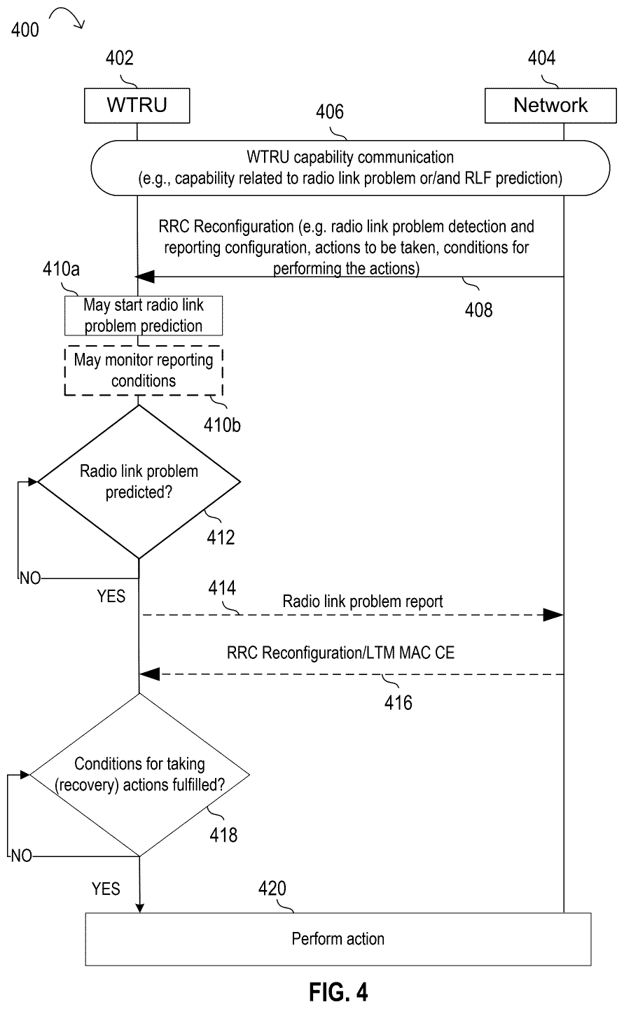

FIG. 4 depicts an example flow chart diagram 400 of one or more embodiments described herein.

At 406, the WTRU 402 may inform the network about capabilities related to radio link problem and/or radio link recovery and/or radio link failure prediction. For example, the WTRU 402 may send, via the transceiver, capability information, (e.g., in a capability report) of the WTRU, related to the radio link problem.

At 408, the WTRU may receive configuration information. The configuration information may regard radio link problem prediction. The configuration may include one or more of the following. The configuration may include parameters related to radio link problem determination and/or prediction (e.g., N310 counter values, lead time, confidence levels, etc.). The configuration may include reporting configuration. For example, the WTRU may be configured to not send a prediction report and/or take an action instead when the condition(s) for executing the action(s) are fulfilled. The configuration may include one or more actions to be taken. For example, the one or more configured actions may be provided in signaling (e.g., at 416, via RRC Reconfiguration/LTM MAC CE. The configuration may include one or more conditions for taking the one or more actions. For example, the one or more conditions may be provided in signaling (e.g., at 416, via RRC Reconfiguration/LTM MAC CE). The gNB 404 may send the WTRU 402 the configuration information (e.g., via RRC Reconfiguration message). The WTRU 402 may receive, via the transceiver, configuration information. The configuration information may include radio link problem prediction parameters (e.g., parameters including N310 that the WTRU may need to check and/or predict) and/or associated radio link recovery actions. For example, the WTRU may receive configuration information that includes the number of OOS required to determine a radio link problem has happened and/or the number of in sync (IS) required to determine the radio link has recovered (and/or to predict if recovery is going to happen before T310 expires). The configuration information may include reporting conditions. The WTRU may receive one or more of the following configurations: configuration related to reduction of a radio link problem; configuration to radio link recovery action(s) to be taken based on a predicted radio link problem, and/or configuration related to conditions for performing the action(s). The condition(s) may be related to the partial and/or full fulfillment of the predictions.

The WTRU 402 may monitor radio link conditions.

At 410a, the WTRU 402 may perform the prediction of radio link problem (e.g., according to the received parameters). The WTRU 402 may predict, based on the radio link problem prediction parameters and/or the radio link conditions, an occurrence of the radio link problem within a period of time. For example, the WTRU may use non-AI/ML model (e.g., one or more statistical model(s), time series forecasting, etc.) and/or AI/ML model(s) predict the occurrence of the radio link problem within the period of time. The WTRU may use at least one AI/ML model to predict the occurrence of the radio link problem.

At 410b, the WTRU 402 may, if reporting was configured, start monitoring the radio link problem reporting configuration(s). In examples, the condition(s) for predicting the problem and/or sending the report may be the same (e.g., the WTRU may send the report, if configured, when the radio link problem is predicted). In examples, the condition(s) for predicting the problem and/or sending the prediction report may be different.

At 412, the WTRU 402 may determine if the condition(s) for the prediction of a radio link problem are fulfilled. For example, the WTRU 402 may determine that the prediction of the occurrence of the radio link problem is partially and/or fully fulfilled within a time window before and/or after the predicted period of time. A WTRU configured to determine that the prediction of the occurrence of the radio link problem may include a WTRU configured to determine that a percentage and/or a number of (e.g., consecutive) out of sync (OOS) indicators are detected (e.g., as compared to the N310). A WTRU configured to determine that the prediction of the occurrence of the radio link problem is fully fulfilled may include a WTRU configured to determine that the radio link problem is (e.g., actually) detected (e.g., N310 consecutive OOS detected).

At 414, if reporting was configured, the WTRU 402 may send the radio link prediction report (e.g., to the network 404) and/or may include (e.g., any) additional information according to the configuration (e.g., measurement information, time information, confidence levels, etc.). For example, the WTRU 402 may send a (e.g., radio link problem) report based on the reporting conditions. The WTRU may send the prediction report to a network node upon predicting that the radio link problem is expected to happen with a given lead time.

At 416, if the WTRU 402 has sent a report, for example, the WTRU 402 may receive a response message from the network 404. The response message may include an action to be taken by the WTRU and/or an indication of an action (e.g., RRC reconfiguration, activation of a CHO/LTM, indication of a CHO/LTM to be executed, etc.). The response message may include a condition when the WTRU may take the indicated action(s). For example, the WTRU 402 may receive a response message that indicates one or more actions the WTRU 402 is to take, and/or one or more conditions associated with the one or more indicated actions.

At 418, the WTRU 402 may determine if the condition(s) for taking the action are fulfilled (e.g., action condition(s) indicated as described herein). For example, the WTRU 402 may monitor the reporting conditions to predict whether radio link recovery is likely to occur. The WTRU 402 may predict, via the at least one AI/ML model, whether radio link recovery is likely to occur before an expiration of a timer.

The WTRU may perform a second prediction to determine whether there will not be radio link recovery within a period of time. For example, N311 consecutive ISs may be detected within a certain time, for example, T310, after the radio link problem is detected. The WTRU may use one or more AI/ML models to perform the second prediction. The WTRU may monitor in sync (IS) indicators to determine whether there will not be radio link recovery within the period of time.

At 420, the WTRU 402 may perform the action(s) (e.g., HO, CHO/LTM, re-establishment, etc.). If the WTRU notices that the radio link problem is going to happen partially and/or fully within a certain duration of the predicted time, the WTRU may perform one or more recovery actions. For example, the WTRU may start the recovery action (e.g., immediately). For example, the WTRU may start the T310 timer (e.g., without the need to wait for the whole N310 OOS, for example, at half of the OOSs), and/or (e.g., then) take an action (e.g., only) when T310 actually expires. For example, the WTRU may predict to determine if there will be recovery within T310 (e.g., the WTRU may perform a new prediction at that time to see if T310 is expected to expire before N311 ISs are detected). If the prediction is that there will be no recovery, the WTRU may take the recovery action already (e.g., no need to wait for T310). For example, the WTRU 402 may perform the associated radio link recovery action based on the determination that the prediction of the occurrence of the radio link problem is partially and/or fully fulfilled within the time window before and/or after the predicted period of time. The WTRU may perform the associated radio link recovery action based on the second prediction and/or a determination that there will not be radio link recovery within the period of time. The associated radio link recovery action may include one or more of applying a radio resource reconfiguration message, applying a recovery mechanism to recover and/or maintain radio link connection, and/or executing radio link re-establishment. The WTRU 402 may execute handover (HO), conditional HO (CHO), and/or a LTM action based on a determination that radio link recovery is not likely to occur.

1. A wireless transmit/receive unit (WTRU) comprising:
a transceiver; and
a processor configured to:
receive, via the transceiver, configuration information comprising radio link problem prediction parameters and associated radio link recovery actions;
monitor radio link conditions;
predict, based on the radio link problem prediction parameters and the radio link conditions, an occurrence of a radio link problem within a period of time;
determine that the prediction of the occurrence of the radio link problem is partially or fully fulfilled within a time window before or after the predicted period of time; and
perform the associated radio link recovery action based on the determination that the prediction of the occurrence of the radio link problem is partially or fully fulfilled within the time window before or after the predicted period of time.

2. The WTRU of claim 1, wherein the configuration information comprises reporting conditions, wherein processor is further configured to send a report based on the reporting conditions.

3. The WTRU of claim 1, wherein the processor is configured to use at least one artificial intelligence (AI)/machine learning (ML) model to predict the occurrence of the radio link problem.

4. The WTRU of claim 3, wherein the processor is configured to send, via the transceiver, capability information, of the WTRU, related to the radio link problem.

5. The WTRU of claim 1, wherein the processor being configured to determine that the prediction of the occurrence of the radio link problem is partially fulfilled comprises the processor being configured to determine a percentage or number of out of sync (OOS) indicators are detected.

6. The WTRU of claim 1, wherein the processor being configured to determine that the prediction of the occurrence of the radio link problem is fully fulfilled comprises the processor being configured to determine that the radio link problem is detected.

7. The WTRU of claim 1, wherein the processor is configured to:
perform a second prediction to determine whether there will not be radio link recovery within a period of time;
monitor in sync (IS) indicators to determine whether there will not be radio link recovery within the period of time; and
perform the associated radio link recovery action based on the second prediction and a determination that there will not be radio link recovery within the period of time, wherein the associated radio link recovery action comprises one or more of applying a radio resource reconfiguration message, applying a recovery mechanism to recover or maintain radio link connection, or executing radio link re-establishment.

8. The WTRU of claim 1, wherein the processor is further configured to send a prediction report based on the prediction of the occurrence of the radio link problem within the period of time.

9. The WTRU of claim 1, wherein the processor is further configured to receive a response message, wherein the response message comprises an indication of one or more actions the WTRU is to take, or one or more conditions associated with the one or more indicated actions.

10. The WTRU of claim 1, wherein the processor is further configured to: execute a handover, conditional handover, or lower-layered triggered mobility action based on a determination that radio link recovery is not likely to occur.

11. A method performed by wireless transmit/receive unit (WTRU), the method comprising:
receiving configuration information comprising radio link problem prediction parameters and associated radio link recovery actions;
monitoring radio link conditions;
predicting, based on the radio link problem prediction parameters and the radio link conditions, an occurrence of a radio link problem within a period of time;
determining that the prediction of the occurrence of the radio link problem is partially or fully fulfilled within a time window before or after the predicted period of time; and
performing the associated radio link recovery action based on the determination that the prediction of the occurrence of the radio link problem is partially or fully fulfilled within the time window before or after the predicted period of time.

12. The method of claim 11, wherein the configuration information comprises reporting conditions, and wherein the method further comprising sending a report based on the reporting conditions.

13. The method of claim 11, further comprising using at least one artificial intelligence (AI)/machine learning (ML) model to predict the occurrence of the radio link problem.

14. The method of claim 13, further comprising sending capability information, of the WTRU, related to the radio link problem.

15. The method of claim 11, wherein determining that the prediction of the occurrence of the radio link problem is partially fulfilled comprises determining a percentage or number of out of sync (OOS) indicators are detected.

16. The method of claim 11, wherein determining that the prediction of the occurrence of the radio link problem is fully fulfilled comprises determining that the radio link problem is detected.

17. The method of claim 11, further comprising:
performing a second prediction to determine whether there will not be radio link recovery within a period of time;
monitoring in sync (IS) indicators to determine whether there will not be radio link recovery within the period of time; and
performing the associated radio link recovery action based on the second prediction and a determination that there will not be radio link recovery within the period of time, wherein the associated radio link recovery action comprises one or more of applying a radio resource reconfiguration message, applying a recovery mechanism to recover or maintain radio link connection, or executing radio link re-establishment.

18. The method of claim 11, further comprising sending a prediction report based on the prediction of the occurrence of the radio link problem within the period of time.

19. The method of claim 11, further comprising receiving a response message, wherein the response message comprises an indication of one or more actions the WTRU is to take, or one or more conditions associated with the one or more indicated actions.

20. The method of claim 11, further comprising: executing a handover, executing a conditional handover, or executing a lower-layered triggered mobility action based on a determination that radio link recovery is not likely to occur.
